(19) United States
(12) Patent Application Publication
(10) Pub. No.: US 2024/0116551 A1
(43) Pub. Date: Apr. 11, 2024

(54) DEGRADED TRAIN EMERGENCY RESCUE METHOD AND APPARATUS BASED ON VEHICLE-VEHICLE COMMUNICATION

(71) Applicant: BYD COMPANY LIMITED, SHENZHEN (CN)

(72) Inventors: Chujun CHEN, Shenzhen (CN); Meizhu CHEN, Shenzhen (CN)

(21) Appl. No.: 18/542,112

(22) Filed: Dec. 15, 2023

Related U.S. Application Data
(63) Continuation of application No. PCT/CN2022/112013, filed on Aug. 12, 2022.

(30) Foreign Application Priority Data
Aug. 13, 2021 (CN) 202110931401.9

(51) Int. Cl. B61L 15/00

(52) U.S. Cl. CPC B61L 15/0018

(57) ABSTRACT

A method for a degraded train emergency rescue includes: obtaining a communication status of a private communication network that connects a train to a ground system, to a front train, and to a rear train; determining whether the private communication network fails based on the communication status; in response to determining that the private communication network fails, restarting an on-board private network switch of the train; determining whether the private communication network is recovered after the on-board private network switch is restarted; in response to determining that the private communication network is not recovered, starting an on-board public network switch of the train, and establishing public network communication between the train and each of the front train and the rear train; and performing an emergency rescue through a public network.

This application is a Continuation Application of International Patent Application No. PCT/CN2022/112013, filed on Aug. 12, 2022, which is based on and claims priority to and benefits of Chinese Patent Application No. 202110931401.9, filed on Aug. 13, 2021. The entire content of all of the above-referenced applications is incorporated herein by reference.

### FIELD

The present disclosure relates to the technical field of rail transit, and more particularly, to a degraded train emergency rescue method and apparatus based on vehicle-to-vehicle communication.

### BACKGROUND

In the related art, the rail transit industry adopts a private network to ensure the system security and redundant designs to improve the system reliability. However, the rail transit industry still faces a problem of a signal system failure caused by a network failure.

Generally, a private network and a public network are integrated to implement communication docking between a public network dispatch system and an LTE-R private network traffic dispatch system. In response to increased intelligence of train signal systems, a full-automatic driverless train can now have no driver. When a fault occurs in a private network, personnel need to rush to a location of the fault from a station to rescue, which requires a considerable amount of manpower, material resources, and financial resources. In addition, if passengers stay at the location of the fault for a long time, a commotion may occur. Fault-based rescue needs to be considered, and how to reduce the impact of a fault is a problem urgently to be resolved.

### SUMMARY

Embodiments of the present disclosure is to provide a method and apparatus for emergency rescue of a degraded train. According to the method, a private network switch may be automatically restarted when a private communication network fails, and if the private communication network cannot be recovered through restart of the switch, a standby public network is enabled for an autonomous rescue, thereby quickly completing the rescue.

According to a first aspect of the embodiments of the present disclosure, a method for a degraded train emergency rescue is provided. The method includes: obtaining a communication status of a private communication network that connects a train to a ground system, to a front train, and to a rear train; determining whether the private communication network fails based on the communication status; in response to determining that the private communication network fails, restarting an on-board private network switch of the train; determining whether the private communication network is recovered after the on-board private network switch is restarted; in response to determining that the private communication network is not recovered, starting an on-board public network switch of the train, and establishing public network communication between the train and each of the front train and the rear train; and performing an emergency rescue through a public network.

According to a second aspect of the embodiments of the present disclosure, an apparatus for a degraded train emergency rescue is provided. The apparatus includes a memory and a processor.

The memory is configured to store a computer program.

The processor is configured to execute the computer program, to implement the method of the first aspect of the embodiments of the present disclosure.

The apparatus relies on installation of the private network and the public network on an on-board device, and adopts automatic restart of the private network while ensuring security of the system. The integration of the private network and the public network improves feasibility of the system. The apparatus may start operation as soon as possible after the system fails.

In a third aspect, the present disclosure provides a non-transitory computer-readable storage medium, storing instructions. The instructions are executed by a processor to cause the processor to implement the method of the first aspect of the embodiments of the present disclosure.

Through the above technical solutions, the train may quickly be rescued after the private communication network fails. After the faulty vehicle automatically runs to a platform, rescue personnel may provide a rescue at the platform. This reduces rescue costs.

Other features and advantages of the implementations of the present disclosure will be described in detail in the following detailed description.

### BRIEF DESCRIPTION OF THE DRAWINGS

The drawings provide further understanding of the implementations of the present disclosure and constitute a part of this specification. The drawings and the following detailed description are used together for explaining the implementations of the present disclosure rather than constituting a limitation on the implementations of the present disclosure. In the drawings:

FIG. 1 is a flowchart of a method for a degraded train emergency rescue according to an implementation of the present disclosure.

FIG. 2 is a block diagram of an apparatus for a degraded train emergency rescue according to an implementation of the present disclosure.

FIG. 3 is a flowchart of the method for a degraded train emergency rescue according to an implementation of the present disclosure.

### DETAILED DESCRIPTION

Implementations of the present disclosure are described in detail below with reference to the drawings. It should be understood that the implementations described herein are used to describe and explain the present disclosure, and do no limit the present disclosure.

A train in the present disclosure is provided with two types of networks: a private network and a public network. In some embodiments, the private network may be an LTE-U or LTE-M private network, and is used for vehicle-to-ground communication and vehicle-to-vehicle communication. The public network may be a frequently used mobile network, such as a 4G network or a 5G network, and is used for communication when the private network fails. In some embodiments, the private network may be a 5G private network or the like. The present disclosure is described in detail by using the LTE-U private network or the LTE-M private network as an example.

FIG. 1 is a flowchart of a method for a degraded train emergency rescue based on vehicle-to-vehicle communication according to an implementation of the present disclosure. As shown in FIG. 1, the method includes the following steps.

A communication status of a private communication network that connects a train to a ground system, to a front train, and to a rear train is obtained.

It is determined whether the private communication network of the train fails based on the communication status.

An on-board private network switch of the train is restarted if it is determined that the private communication network fails.

It is determined whether the private communication network is recovered after the on-board private network switch is restarted.

An on-board public network switch of the train is started if it is determined that the private communication network is not recovered. Public network communication is established between the train and each of the front train and the rear train.

An emergency rescue is performed through a public network.

If the private communication network is recovered after the on-board private network switch is restarted, the train releases braking and resumes running. During running, the train communicates with the ground system and the front train and the rear train through the private communication network based on a communication period. In the communication period, the train stores information about the front train and the rear train in the current communication period. The information about the front train and the rear train includes identifiers of the front train and the rear train, locations of the front train and the rear train, a current communication time node, and the like. If the communication between the train and the ground system and the communication among the train and each of the front train and the rear train are interrupted, the private network fails. In this case, the vehicle stops on a main track as a result of the communication failure. After the failure of the private network is detected, the private network switch is automatically restarted. If the private network is successfully recovered after the restart and the communication between the train and the ground system or the front train and the rear train becomes normal, the train releases the braking and resumes running. Otherwise, a public network needs to be established, and an emergency rescue is performed through the public network.

In some embodiments, a restart quantity may be set for the private network switch. When the restart quantity is reached but the private network is still not recovered, it is determined that the private network cannot be recovered. In this case, the public network is established for an emergency rescue.

In some embodiments, that public network communication is established between the train and each of the front train and the rear train includes the following step.

The front train and the rear train of the train are called based on historical information of the front train and the rear train stored in the train, to establish the public network communication between the train and each of the front train and the rear train. The information about the front train and the rear train includes the identifiers of the front train and the rear train. The identifiers of the front train and the rear train are similar to a vehicle ID, and are unique over the world. Vehicles call each other through the vehicle ID.

In some embodiments, that an emergency rescue is performed through a public network includes the following steps.

Fault information of the train is transmitted to the front train and the rear train. The front train and the rear train are requested to report the fault information of the train to a control center through private communication networks of the front train and the rear train, such as a front private communication network of the front train and a rear private communication network of the rear train.

After vehicle-to-vehicle or vehicle-to-ground private network communication of the train fails, the train stops on the main track, and cannot communicate with the control center or other trains through the private network. Through enabling of the public network, the train may temporarily communicate with other trains through the public network, and request other trains to report the fault information to the control center through the private network of other trains. In this way, the fault information may be reported in a timely manner. In any case, the center will dispatch trains on the same track line after receiving the train fault information, to avoid an accident, even if the communication through the private network fails. In the present disclosure, the front train and the rear train may immediately report the fault information to the center after receiving the forwarding request, and the center can quickly make responses after receiving the fault information forwarded by the front train or the rear train. The center dispatches other trains that need to pass through the area that the faulty train is located, and prohibits other vehicles from entering the faulty area through manual intervention, to ensure the operating safety of the train. In addition, the communication between the center and other trains is still performed through the private network, which ensures data security of the center.

In this embodiment, the fault information includes information indicating a location where the train stops on the main track and fault information of the private communication network of the train. The network fault information is LTE-U/M private network fault information. The information indicating the location where the train stops on the main track may be used for the center to define an area requiring safety control, to avoiding an accident. The fault information of the private communication network of the train may help the center to obtain an abnormality of the train, and dispatch maintenance, rescue, and passenger loading/unloading operations.

In some embodiments, after the train stops on the main track, a latest location of the front train obtained before the communication is interrupted is used as a danger point for protection. After the communication fails, the communication between the train and other trains is interrupted, and travel information of other trains cannot be transmitted to the faulty train. However, after the fault is reported, the center provides dispatch, and uses the latest location of the front train as the danger point for the faulty train, which can ensure travel safety of the faulty train and adjacent trains.

In some embodiments, that an emergency rescue is performed through a public network includes the following steps.

A location of a nearest platform in a running direction of the train is queried based on the information indicating the location where the train stops on the main track and an electronic map stored in an on-board system of the train.

It is determined based on a latest location of the front train obtained by the train before communication through the private communication network is interrupted whether a front train running in the same direction of the train exists between the location where the train stops on the main track and the nearest platform in the running direction of the train.

It is determined whether a distance (e.g., a track distance) between the front train and the train satisfies a virtual attaching condition, that is, it is determined whether the distance is less than a length of one train, if the front train running in the same direction of the train exists. A virtual coupling request is initiated to the front train if the virtual attaching condition is satisfied, to couple the train with the front train to form a virtual train. The coupling of the train with the front train is released after the virtual train travels to the nearest platform. A radar detector of the train is started and the train is controlled to run to the nearest platform at e.g., a limited speed if the virtual attaching condition is not satisfied.

The radar detector of the train is started and the train is controlled to run to the nearest platform if the front train running in the same direction does not exist. After the coupling is released, the faulty train receives a rescue at the nearest platform, and the front train continues to run as planned.

A distance is generally meant for a straight line between two points. However, during construction of railway tracks, factors such as terrain need to be considered, which is unnecessarily a straight line. Therefore, during the determination whether the front train running in the same direction exists, a traveled distance is calculated based on a railway track map, the location where the train stops on the main track, the location of the nearest platform, and the latest location of the front train obtained by the train. Then, it is determined whether the front train running in the same direction exists based on the traveled distance between the train and the front train and the traveled distance between the train and the nearest platform.

In an embodiment, the following steps are included.

A first traveled distance is determined based on the location where the train stops on the main track and the location of the nearest platform. The first traveled distance represents a track length between the train and the nearest platform.

A second traveled distance is determined based on the location where the train stops on the main track and the latest location of the front train obtained by the train. The second traveled distance represents a track length between the train and the front train.

The first traveled distance is compared with the second traveled distance.

It is determined that the front train running in the same direction exists between the location where the train stops on the main track and the nearest platform in the running direction of the train, if the first traveled distance is greater than the second traveled distance.

It is determined that the front train running in the same direction does not exist between the location where the train stops on the main track and the nearest platform in the running direction of the train, if the first traveled distance is less than or equal to the second traveled distance.

It should be noted that, the traveled distance may be calculated by map navigation, and is not described in detail in the present disclosure.

The faulty train determines the location of the nearest platform, determines whether a train running in the same direction exists, and performs virtual coupling and travels to the nearest platform when the train running in the same direction exists and the virtual coupling condition is satisfied. Otherwise, the faulty train autonomously runs to the nearest platform. The train does not need to wait for the center to dispatch a rescue vehicle to the location of the faulty train from the platform, which reduces a rescue time, and the faulty train does not stop on the main track for a long time, which avoids panic and anxiety of passengers.

In an embodiment, that a virtual coupling request is initiated to the front train, to couple the train with the front train to form a virtual train includes the following steps.

The front train determines whether a virtual coupling requirement is satisfied after the virtual coupling request is initiated to the front train. The front train initiates the virtual coupling request to the control center when the virtual coupling requirement is satisfied.

The train is coupled with the front train to form the virtual train based on virtual coupling confirmation information received from the control center. The front train calculates envelope information of the virtual train based on envelope information of the front train, the distance between the front train and the train, and envelope information of the train, reports the location of the train to the control center based on the envelope information of the virtual train, and communicates with a front train (e.g., a first front train) and a rear train (e.g., a first rear train) of the virtual train. In some embodiments, the communication with the front and rear trains of the virtual train can be performed simultaneously.

The front train in the virtual train periodically shares control information with the train.

In this embodiment, the control information includes a traction/braking instruction, an advancement/retreat instruction, and vehicle control level information. The faulty train performs virtual coupling with the front train, and may share the control information, so that running conditions of two trains in the virtual train are consistent. The front train is used as an eye of the entire virtual train, which obtains a traction/braking instruction, an advancement/retreat instruction, and vehicle control level information from vehicle-to-vehicle communication and vehicle-to-ground communication. This protects the system safety.

During the rescue, the front train communicates with the center through the private network, and the faulty train communicates with the front train through the public network. In order to ensure correctness of data transmission through the public network, a secure communication protocol needs to be used as a vehicle-to-vehicle communication protocol.

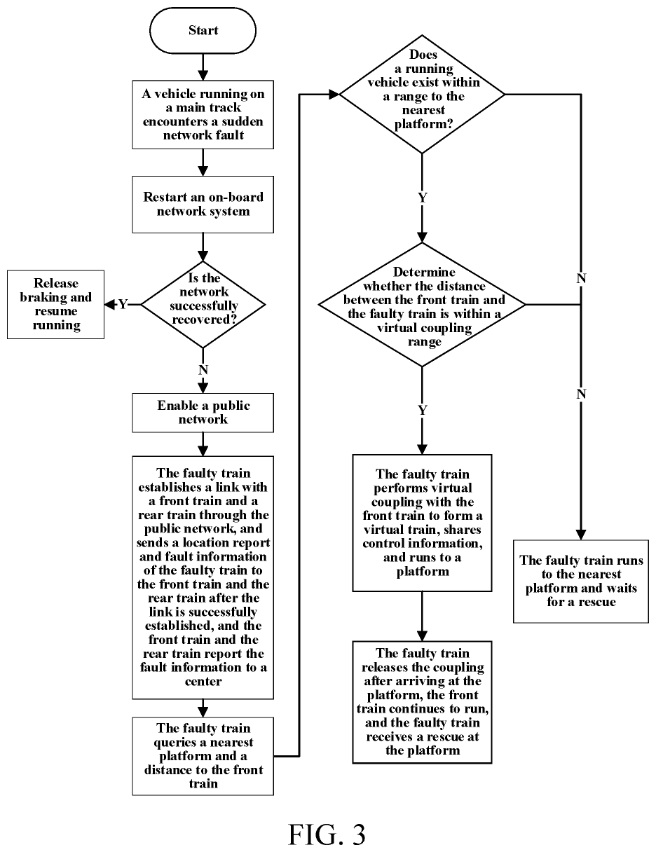

During operations, as shown in FIG. 3, after a vehicle running on the main track encounters a sudden private network fault and stops on the main track, the on-board private network switch is restarted. If the network is successfully recovered after the restart, the braking is released and the running is resumed. If the network is not successfully recovered, the public network is enabled. The faulty train establishes links with the front train and the rear train through the public network, and sends the location report and the fault information of the faulty train to the front train and the rear train after the links are successfully established. The front train and the rear train report the fault information to the center. After reporting the fault, the faulty train queries the nearest platform and the distance to the front train, determines whether a running vehicle exists within the distance to the nearest platform, and further determines whether the distance between the front train and the faulty train is within a virtual coupling range if such a running vehicle exists. The faulty train enables a virtual coupling function if the distance is within the virtual coupling range, performs virtual coupling with the front train to form the virtual train, shares the control information, safely travels to the platform, and releases the coupling after arriving at the platform. The front train continues to run, and the faulty train receives a rescue at the platform. If no running vehicle exists within the distance to the nearest platform, or the train is not within the virtual coupling range, the faulty train runs to the nearest platform and waits for a rescue.

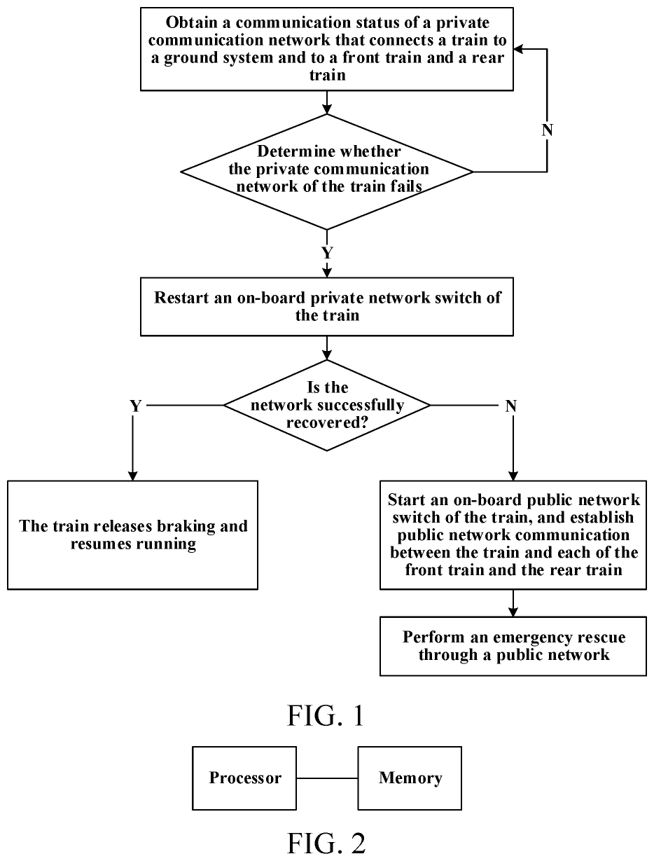

FIG. 2 is a block diagram of an apparatus for a degraded train emergency rescue based on vehicle-to-vehicle communication according to an implementation of the present disclosure. As shown in FIG. 2, the apparatus includes a memory and a processor.

The memory is configured to store a computer program.

The processor is configured to execute the computer program, to implement the following steps.

A communication status of a private communication network that connects a train to a ground, to a front train, and to a rear train is obtained.

It is determined whether the private communication network of the train fails based on the communication status.

An on-board private network switch of the train is restarted if it is determined that the private communication network fails.

It is determined whether the private communication network is recovered after the on-board private network switch is restarted.

An on-board public network switch of the train is started if it is determined that the private communication network is not recovered. Public network communication is established between the train and each of the front train and the rear train.

An emergency rescue is performed through a public network. The apparatus relies on installation of the private network and the public network on an on-board device, and adopts automatic restart of the private network while ensuring security of the train. The integration of the private network and the public network improves feasibility of the communication system. The apparatus may start operation as soon as possible after the private network communication system fails.

In some embodiments, that public network communication is established between the train and each of the front train and the rear train includes the following step.

The front train and the rear train of the train are called based on historical information of the front train and the rear train stored in the train, to establish the public network communication between the train and each of the front train and the rear train. The information about the front train and the rear train includes the identifiers of the front train and the rear train. The identifiers of the front train and the rear train are similar to a vehicle ID, and are unique over the world. Vehicles call each other through the vehicle ID.

In some embodiments, that an emergency rescue is performed through a public network includes the following steps.

Fault information of the train is transmitted to the front train and the rear train. The front train and the rear train are requested to report the fault information of the train to a control center through private communication networks of the front train and the rear train.

After vehicle-to-vehicle or vehicle-to-ground private network communication of the train fails, the train stops on the main track, and cannot communicate with the control center or other trains through the private network. Through enabling of the public network, the train may temporarily communicate with the other trains through the public network, and request the other trains to report the fault information to the center through the private network of other trains. In this way, the fault information may be reported in a timely manner. In any case, the center will dispatch trains on the same track line after receiving the train fault information, to avoid an accident, even if the communication through the private network fails. In the present disclosure, the front train and the rear train immediately report the fault information to the center after receiving the forwarding request, and the center can quickly make responses after receiving the fault information forwarded by the front train and the rear train. The center dispatches other trains that need to pass through the area that the faulty train is located, and prohibits other vehicles from entering the faulty area through manual intervention, to ensure the operation safety of the train. In addition, the communication between the center and other trains is still performed through the private network, which ensures data security of the center.

In this embodiment, the fault information includes information indicating a location where the train stops on the main track and fault information of the private communication network of the train. The network fault information is LTE-U/M private network fault information. The information indicating the location where the train stops on the main track may be used for the center to define an area requiring safety control, to avoiding an accident. The fault information of the private communication network of the train may help the center to obtain an abnormality of the train, and dispatch maintenance, rescue, and passenger loading/unloading operations.

In some embodiments, after the train stops on the main track, a latest location of the front train obtained before the communication is interrupted is used as a danger point for protection. After the communication fails, the communication between the train and other trains is interrupted, and travel information of other trains cannot be transmitted to the faulty train. However, after the fault is reported, the center provides dispatch, and uses the latest location of the front train as the danger point for the faulty train, which can ensure travel safety of the faulty train and adjacent trains.

In some embodiments, that an emergency rescue is performed through a public network includes the following steps.

A location of a nearest platform in a running direction of the train is queried based on the information indicating the location where the train stops on the main track and an electronic map stored in an on-board system of the train.

It is determined based on a latest location of the front train obtained by the train before communication through the private communication network is interrupted whether a front train running in the same direction of the train exists between the location where the train stops on the main track and the nearest platform in the running direction of the train.

It is determined whether a distance (e.g., a track distance) between the front train and the train satisfies a virtual attaching condition, that is, it is determined whether the distance is less than a length of one train, if the front train running in the same direction of the train exists. A virtual coupling request is initiated to the front train if the virtual attaching condition is satisfied, to couple the train with the front train to form a virtual train. The coupling of the train with the front train is released after the virtual train travels to the nearest platform. A radar detector of the train is started and the train is controlled to run to the nearest platform if the virtual attaching condition is not satisfied.

The radar detector of the train is started and the train is controlled to run to the nearest platform if the front train running in the same direction does not exist. After the coupling is released, the faulty train receives a rescue at the nearest platform, and the front train continues to run as planned.

A distance is generally meant for a straight line between two points. However, during construction of railway tracks, factors such as terrain need to be considered, which is unnecessarily a straight line. Therefore, during the determination whether the front train running in the same direction exists, a traveled distance is calculated based on a railway track map, the location where the train stops on the main track, the location of the nearest platform, and the latest location of the front train obtained by the train. Then, it is determined whether the front train running in the same direction exists based on the traveled distance between the train and the front train and the traveled distance between the train and the nearest platform.

In an embodiment, the following steps are included.

A first traveled distance is determined based on the location where the train stops on the main track and the location of the nearest platform. The first traveled distance represents a track length between the train and the nearest platform.

A second traveled distance is determined based on the location where the train stops on the main track and the latest location of the front train obtained by the train. The second traveled distance represents a track length between the train and the front train.

The first traveled distance is compared with the second traveled distance.

It is determined that the front train running in the same direction exists between the location where the train stops on the main track and the nearest platform in the running direction of the train if the first traveled distance is greater than the second traveled distance.

It is determined that the front train running in the same direction does not exist between the location where the train stops on the main track and the nearest platform in the running direction of the train if the first traveled distance is less than or equal to the second traveled distance.

It should be noted that, the traveled distance may be calculated by map navigation, and is not described in detail in the present disclosure.

The faulty train determines the location of the nearest platform, determines whether a train running in the same direction exists, and performs virtual coupling and travels to the nearest platform when the train running in the same direction exists and the virtual coupling condition is satisfied. Otherwise, the faulty train autonomously runs to the nearest platform. The train does not need to wait for the center to dispatch a rescue vehicle to the location of the faulty train from the platform, which reduces a rescue time, and the faulty train does not stop on the main track for a long time, which avoids panic and anxiety of passengers.

In an embodiment, that a virtual coupling request is initiated to the front train, to couple the train with the front train to form a virtual train includes the following steps.

The front train determines whether a virtual coupling requirement is satisfied after the virtual coupling request is initiated to the front train. The front train initiates the virtual coupling request to the control center when the virtual coupling requirement is satisfied.

The train is coupled with the front train to form the virtual train based on virtual coupling confirmation information received from the control center. The front train calculates envelope information of the virtual train based on envelope information of the front train, the distance between the front train and the train, and envelope information of the train, reports the location of the train to the control center based on the envelope information of the virtual train, and communicates with a front train (e.g., a first front train) and a rear train (e.g., a first rear train) of the virtual train simultaneously.

The front train in the virtual train periodically shares control information with the train.

In this embodiment, the control information includes a traction/braking instruction, an advancement/retreat instruction, and vehicle control level information. The faulty train performs virtual coupling with the front train, and may share the control information, so that running conditions of two trains in the virtual train are consistent. The front train is used as an eye of the entire virtual train, which obtains a traction/braking instruction, an advancement/retreat instruction, and vehicle control level information from vehicle-to-vehicle communication and vehicle-to-ground communication. This protects the system safety.

In another aspect, the present disclosure provides a machine-readable storage medium, storing instructions. The instructions are configured to cause a machine to perform the degraded train emergency rescue method based on vehicle-to-vehicle communication.

A person skilled in the art may understand that all or some of the steps for implementing the methods in the above embodiments may be completed by a program by instructing related hardware. The program is stored in a storage medium, and includes multiple instructions for enabling a single-chip microcomputer, a chip, or a processor to perform all or some of the steps of the methods in the implementations of the present disclosure. The storage medium includes any medium that may store program code, such as a USB flash drive, a removable hard disk, a read-only memory (ROM), a random access memory (RAM), a magnetic disk, or a compact disc.

The an implementations of the present disclosure are described in detail above with reference to the drawings. However, the implementations of the present disclosure are not limited to the details in the above implementations. Multiple simple variations may be made to the technical solutions of the implementations of the present disclosure within the scope of the technical concept of the implementations of the present disclosure, and these simple variations all fall within the protection scope of the implementations of the present disclosure. In addition, it should be noted that, the technical features described in the above implementations may be combined in any proper manner in case of no contradiction. In order to avoid unnecessary repetition, various possible combination manners are not described in the implementations of the present disclosure.

In addition, different implementations of the present disclosure may also be arbitrarily combined without departing from the idea of the implementations of the present disclosure, and these combinations shall still be regarded as content disclosed in the implementations of the present disclosure.

What is claimed is:

1. A method for a degraded train emergency rescue, comprising:
obtaining a communication status of a private communication network that connects a train to a ground system, to a front train, and to a rear train;
determining whether the private communication network fails based on the communication status;
in response to determining that the private communication network fails, restarting an on-board private network switch of the train;
determining whether the private communication network is recovered after the on-board private network switch is restarted;
in response to determining that the private communication network is not recovered, starting an on-board public network switch of the train, and establishing public network communication between the train and each of the front train and the rear train; and
performing an emergency rescue through a public network.

2. The method according to claim 1, wherein the establishing the public network communication between the train and each of the front train and the rear train comprises:
calling the front train and the rear train based on historical information of the front train and the rear train stored in the train, and establishing the public network communication between the train and each of the front train and the rear train.

3. The method according to claim 1, wherein
the performing the emergency rescue through the public network comprises:
transmitting fault information of the train to the front train and the rear train, and requesting the front train and the rear train to report the fault information to a control center through a front private communication network of the front train and a rear private communication network of the rear train; and
the fault information comprises location information indicating a location of the train on a track and failure information indicating that the private communication network fails.

4. The method according to claim 3, wherein the performing the emergency rescue through the public network comprises:
querying a platform location of a nearest platform in a running direction of the train based on the location of the train on the track and an electronic map stored in an on-board system of the train;
determining, based on a latest location of the front train obtained by the train before communication through the private communication network is interrupted, whether the front train runs in the running direction of the train and between the location of the train on the track and the nearest platform;
in response to determining that the front train runs in the running direction of the train and between the location of the train on the track and the nearest platform, determining whether a track distance between the front train and the train satisfies a virtual attaching condition; in response to determining that the track distance between the front train and the train satisfies the virtual attaching condition, initiating a virtual coupling request to the front train, to couple the train with the front train to form a virtual train, and releasing the coupling of the virtual train after the virtual train travels to the nearest platform; in response to determining that the track distance between the front train and the train does not satisfy the virtual attaching condition, starting a radar detector of the train and controlling the train to run to the nearest platform; and
in response to determining that the front train does not run in the running direction of the train and between the location of the train on the track and the nearest platform, starting the radar detector of the train and controlling the train to run to the nearest platform.

5. The method according to claim 4, wherein the determining whether the front train runs in the running direction of the train and between the location of the train on the track and the nearest platform comprises:
determining a first traveled distance on the track based on the location of the train on the track and the platform location of the nearest platform, the first traveled distance representing a track length between the train and the nearest platform on the track;
determining a second traveled distance based on the location of the train on the track and the latest location of the front train obtained by the train, the second traveled distance representing a track length between the train and the front train on the track;
comparing the first traveled distance with the second traveled distance;
in response to that the first traveled distance is greater than the second traveled distance, determining that the front train runs in the running direction of the train and between the location of the train on the track and the nearest platform; and
in response to that the first traveled distance is less than or equal to the second traveled distance, determining that the front train does not run in the running direction of the train and between the location of the train on the track and the nearest platform.

6. The method according to claim 4, wherein the initiating the virtual coupling request to the front train, to couple the train with the front train to form the virtual train comprises:
determining, by the front train, whether a virtual coupling requirement is satisfied after the virtual coupling request is initiated to the front train, and in response to determining that the virtual coupling requirement is satisfied, initiating, by the front train, the virtual coupling request to the control center; and
receiving virtual coupling confirmation information from the control center, and coupling the train with the front train to form the virtual train, wherein the front train calculates envelope information of the virtual train based on envelope information of the front train, the track distance between the front train and the train, and envelope information of the train, reports the location of the train to the control center based on the envelope information of the virtual train, and communicates with a first front train and a first rear train of the virtual train;
wherein the front train shares control information with the train; and
wherein the control information comprises a traction/braking instruction, an advancement/retreat instruction, and vehicle control level information.

7. An apparatus for a degraded train emergency rescue, comprising:
a memory configured to store a computer program; and
a processor configured to execute the computer program to perform operations comprising:
obtaining a communication status of a private communication network that connects a train to a ground system, to a front train, and to a rear train;
determining whether the private communication network fails based on the communication status;
in response to determining that the private communication network fails, restarting an on-board private network switch of the train;
determining whether the private communication network is recovered after the on-board private network switch is restarted;
in response to determining that the private communication network is not recovered, starting an on-board public network switch of the train, and establishing public network communication between the train and each of the front train and the rear train; and
performing an emergency rescue through a public network.

8. The apparatus according to claim 7, wherein the establishing the public network communication between the train and each of the front train and the rear train comprises:
calling the front train and the rear train based on historical information of the front train and the rear train stored in the train, and establishing the public network communication between the train and each of the front train and the rear train.

9. The apparatus according to claim 7, wherein
the performing the emergency rescue through the public network comprises:
transmitting fault information of the train to the front train and the rear train, and requesting the front train and the rear train to report the fault information to a control center through a front private communication network of the front train and a rear private communication network of the rear train; and
the fault information comprises location information indicating a location of the train on a track and failure information indicating that the private communication network fails.

10. The apparatus according to claim 9, wherein the performing the emergency rescue through the public network comprises:
querying a platform location of a nearest platform in a running direction of the train based on the location of the train on the track and an electronic map stored in an on-board system of the train;
determining, based on a latest location of the front train obtained by the train before communication through the private communication network is interrupted, whether the front train runs in the running direction of the train and between the location of the train on the track and the nearest platform;
in response to determining that the front train runs in the running direction of the train and between the location of the train on the track and the nearest platform, determining whether a track distance between the front train and the train satisfies a virtual attaching condition; in response to determining that the track distance between the front train and the train satisfies the virtual attaching condition, initiating a virtual coupling request to the front train, to couple the train with the front train to form a virtual train, and releasing the coupling of the virtual train after the virtual train travels to the nearest platform; in response to determining that the track distance between the front train and the train does not satisfy the virtual attaching condition, starting a radar detector of the train and controlling the train to run to the nearest platform; and
in response to determining that the front train does not run in the running direction of the train between the location of the train on a track and the nearest platform, starting the radar detector of the train and controlling the train to run to the nearest platform.

11. The apparatus according to claim 10, wherein the determining whether the front train runs in the running direction of the train and between the location of the train on the track and the nearest platform comprises:
determining a first traveled distance on the track based on the location of the train on the track and the platform location of the nearest platform, the first traveled distance representing a track length between the train and the nearest platform on the track;
determining a second traveled distance based on the location of the train on the track and the latest location of the front train obtained by the train, the second traveled distance representing a track length between the train and the front train on the track;
comparing the first traveled distance with the second traveled distance;
in response to that the first traveled distance is greater than the second traveled distance, determining that the front train runs in the running direction of the train and between the location of the train on the track and the nearest platform; and
in response to that the first traveled distance is less than or equal to the second traveled distance, determining that the front train does not run in the running direction of the train and between the location of the train on the track and the nearest platform.

12. The apparatus according to claim 10, wherein the initiating the virtual coupling request to the front train, to couple the train with the front train to form the virtual train comprises:
determining, by the front train, whether a virtual coupling requirement is satisfied after the virtual coupling request is initiated to the front train, and in response to determining that the virtual coupling requirement is satisfied, initiating, by the front train, the virtual coupling request to the control center; and
receiving virtual coupling confirmation information from the control center, and coupling the train with the front train to form the virtual train, wherein the front train calculates envelope information of the virtual train based on envelope information of the front train, the track distance between the front train and the train, and envelope information of the train, reports the location of the train to the control center based on the envelope information of the virtual train, and communicates with a first front train and a first rear train of the virtual train;
wherein the front train shares control information with the train; and
wherein the control information comprises a traction/braking instruction, an advancement/retreat instruction, and vehicle control level information.

13. A non-transitory computer-readable storage medium storing instructions, the instructions being executed by a processor to cause the processor to perform operations comprising:
obtaining a communication status of a private communication network that connects a train to a ground system, to a front train, and to a rear train;
determining whether the private communication network fails based on the communication status;
in response to determining that the private communication network fails, restarting an on-board private network switch of the train;
determining whether the private communication network is recovered after the on-board private network switch is restarted;
in response to determining that the private communication network is not recovered, starting an on-board public network switch of the train, and establishing public network communication between the train and each of the front train and the rear train; and
performing an emergency rescue through a public network.

14. The medium according to claim 13, wherein the establishing the public network communication between the train and each of the front train and the rear train comprises:
calling the front train and the rear train based on historical information of the front train and the rear train stored in the train, and establishing the public network communication between the train and each of the front train and the rear train.

15. The medium according to claim 13, wherein
the performing the emergency rescue through the public network comprises:
transmitting fault information of the train to the front train and the rear train, and requesting the front train and the rear train to report the fault information to a control center through a front private communication network of the front train and a rear private communication network of the rear train; and
the fault information comprises location information indicating a location of the train on a track and failure information indicating that the private communication network fails.

16. The medium according to claim 15, wherein the performing the emergency rescue through the public network comprises:
querying a platform location of a nearest platform in a running direction of the train based on the location of the train on the track and an electronic map stored in an on-board system of the train;
determining, based on a latest location of the front train obtained by the train before communication through the private communication network is interrupted, whether the front train runs in the running direction of the train and between the location of the train on the track and the nearest platform;
in response to determining that the front train runs in the running direction of the train and between the location of the train on the track and the nearest platform, determining whether a track distance between the front train and the train satisfies a virtual attaching condition; in response to determining that the track distance between the front train and the train satisfies the virtual attaching condition, initiating a virtual coupling request to the front train, to couple the train with the front train to form a virtual train, and releasing the coupling of the virtual train after the virtual train travels to the nearest platform; in response to determining that the track distance between the front train and the train does not satisfy the virtual attaching condition, starting a radar detector of the train and controlling the train to run to the nearest platform; and
in response to determining that the front train does not run in the running direction of the train between the location of the train on a track and the nearest platform, starting the radar detector of the train and controlling the train to run to the nearest platform.

17. The medium according to claim 16, wherein the determining whether the front train runs in the running direction of the train and between the location of the train on the track and the nearest platform comprises:
determining a first traveled distance on the track based on the location of the train on the track and the platform location of the nearest platform, the first traveled distance representing a track length between the train and the nearest platform on the track;
determining a second traveled distance based on the location of the train on the track and the latest location of the front train obtained by the train, the second traveled distance representing a track length between the train and the front train on the track;
comparing the first traveled distance with the second traveled distance;
in response to that the first traveled distance is greater than the second traveled distance, determining that the front train runs in the running direction of the train and between the location of the train on the track and the nearest platform; and
in response to that the first traveled distance is less than or equal to the second traveled distance, determining that the front train does not run in the running direction of the train and between the location of the train on the track and the nearest platform.

18. The medium according to claim 16, wherein the initiating the virtual coupling request to the front train, to couple the train with the front train to form the virtual train comprises:
determining, by the front train, whether a virtual coupling requirement is satisfied after the virtual coupling request is initiated to the front train, and in response to determining that the virtual coupling requirement is satisfied, initiating, by the front train, the virtual coupling request to the control center; and
receiving virtual coupling confirmation information from the control center, and coupling the train with the front train to form the virtual train, wherein the front train calculates envelope information of the virtual train based on envelope information of the front train, the track distance between the front train and the train, and envelope information of the train, reports the location of the train to the control center based on the envelope information of the virtual train, and communicates with a first front train and a first rear train of the virtual train;
wherein the front train shares control information with the train; and
wherein the control information comprises a traction/braking instruction, an advancement/retreat instruction, and vehicle control level information.
